(19) United States
(12) Patent Application Publication
(10) Pub. No.: US 2018/0107984 A1
(43) Pub. Date: Apr. 19, 2018

(54) CALENDAR MANAGMENT TO PREVENT STRESS

(71) Applicant: INTERNATIONAL BUSINESS MACHINES CORPORATION, Armonk, NY (US)

(72) Inventors: Michael Bender, Rye Brook, NY (US); Gregory J. Boss, Saginaw, MI (US); Rhonda L. Childress, Austin, TX (US); Edward T. Childress, Austin, TX (US)

(21) Appl. No.: 15/294,103

(22) Filed: Oct. 14, 2016

(51) Int. Cl. G06Q 10/10; H04L 29/08

(52) U.S. Cl. CPC G06Q 10/1093; H04L 67/22

(57) ABSTRACT

Systems and methods for managing electronic calendars to reduce user stress are disclosed. In embodiments, a computer-implemented method comprises: receiving, by a computing device, event data associated with a new calendar event; comparing, by the computing device, the event data with one or more stress elevating factors of a user in a stress logging module; and determining, by the computing device, whether the new calendar event is associated with a potential undesirable elevation in the user's stress level based on the comparing the event data with the one or more stress elevating factors.

### BACKGROUND

The present invention relates generally to calendar management and, more particularly, to the management of calendars to prevent user stress.

Workplace-related stress, depression and anxiety can have significant detrimental health effects on individuals, as well as decrease the individual's attention level and productivity. The desire to manage individual stress levels has lead to a variety of methods for tracking individual stress levels, including the use of wearable sensors, such as heart rate monitors. However, such general tracking methods do not provide any remediation of individual stress levels or target a person's individual stress tolerances and stress triggers. In general, people have specific and individualistic sets of triggers that may cause their stress levels to increase. In a business environment, stress triggers may be related to meetings with specific people or situations related to certain topics. Moreover, an individual may already have elevated stress levels due to outside factors that can be exacerbated by certain events, such as meetings, public speaking events, etc. Individuals typically do not want to move directly from one stressful situation to another. However, there does not presently exist a system to manage an individual's schedule in a manner that addresses the individual's particular stress triggers and sensitivities to stress, in order to reduce overall stress levels of the individual throughout the day.

### SUMMARY

In an aspect of the invention, a computer-implemented method for managing electronic calendars to reduce user stress includes: receiving, by a computing device, event data associated with a new calendar event; comparing, by the computing device, the event data with one or more stress elevating factors of a user in a stress logging module; and determining, by the computing device, whether the new calendar event is associated with a potential undesirable elevation in the user's stress level based on the comparing the event data with the one or more stress elevating factors.

In another aspect of the invention, there is a computer program product for managing calendars to reduce user stress. The computer program product comprises a computer readable storage medium having program instructions embodied therewith. The program instructions are executable by a computing device to cause the computing device to: receive stress tracking data associated with a user from one or more tracking devices; record the stress tracking data over a time period; record calendar event data associated with the user over the time period; determine stress elevating factors of the user based on comparing the stress tracking data to the calendar event data; and log the stress elevating factors in a stress logging module.

In another aspect of the invention, there is a system for managing electronic calendars to reduce user stress. The system includes a CPU, a computer readable memory and a computer readable storage medium associated with a computing device. The system also includes program instructions to receive group event information for a group event to be electronically calendared; program instructions to determine intended participants in the group event based on the group event information; program instructions to determine priority levels of each of the intended participants; program instructions to determine stress elevating factors of each of the intended participants associated with the group event; program instructions to determine an optimal scheduling of the group event based on the determined stress elevating factors, including one or more of the intended participants to be invited to the group event as an invitee; and program instructions to initiate scheduling of the group event in the electronic calendars of the one or more invitees based on the determined optimal scheduling, wherein the program instructions are stored on the computer readable storage medium for execution by the CPU via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a computing infrastructure according to an embodiment of the present invention.

FIG. 2 shows an exemplary environment in accordance with aspects of the invention.

FIG. 3 shows a flowchart of steps of a method in accordance with aspects of the invention.

FIG. 4 shows a flowchart of steps of a method in accordance with additional aspects of the invention.

FIG. 5 depicts a user's electronic calendar in accordance with exemplary scenarios of the present invention.

### DETAILED DESCRIPTION

The present invention relates generally to calendar management and, more particularly, to the management of calendars to prevent user stress. In aspects, the present invention uses cognitive analysis of data from trackers or sensors, such as internet of things (IoT) sensors, to track a person's stress levels and mood. In embodiments, the system learns when a person has an elevated stress level and tracks some of the items that may account for the increased level of stress. Some of the items that may increase stress relate to interactions that an individual is experiencing, such as a particular topic at a meeting, who is attending the meeting, or who is the main person that the individual is interacting with. An additional item that may be tracked is the length and number of meetings that an individual is exposed to.

In aspects, initial setup of the present system includes capturing data to set a stress baseline for an individual. As the initial baseline is set, the system then interacts with an individual's electronic calendar and makes recommendations or automatic changes to scheduled events in order to reduce the individual's stress level based on the probability that certain combinations of scheduling events will increase or decrease the individual's stress level. Any conventional electronic calendaring tool can be utilized with the present invention.

In embodiments, the present system will account for additional factors when assessing an individual's stress level, including the individual's level of participating in a meeting. For example, a variety of sensors may be utilized to detect how much an individual is speaking during a meeting and a sentiment analysis tool may be utilized to determine if a user is stressed, relaxed, etc., based on an analysis of documents related to a calendar event.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

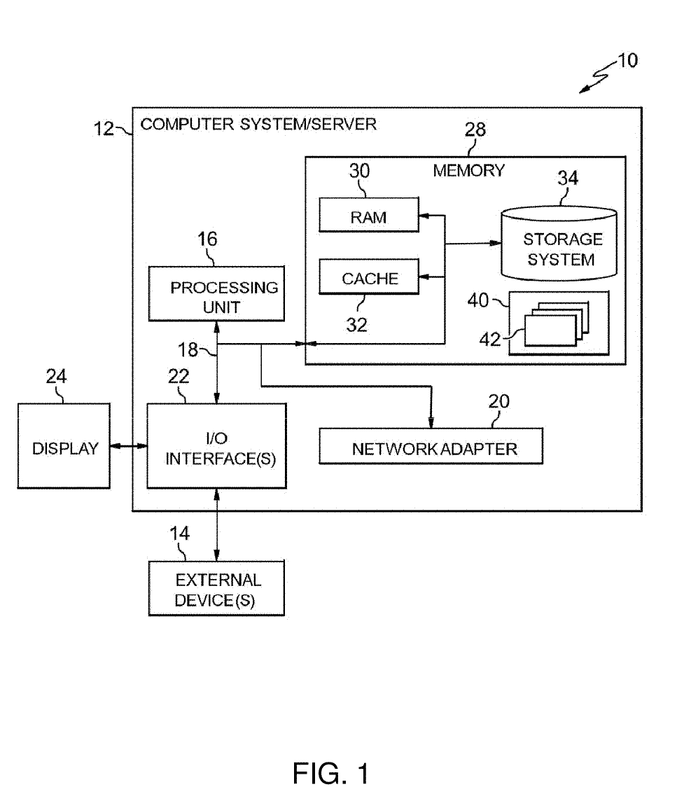

Referring now to FIG. 1, a schematic of an example of a computing infrastructure is shown. Computing infrastructure 10 is only one example of a suitable computing infrastructure and is not intended to suggest any limitation as to the scope of use or functionality of embodiments of the invention described herein. Regardless, computing infrastructure 10 is capable of being implemented and/or performing any of the functionality set forth hereinabove.

In computing infrastructure 10 there is a computer system (or server) 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system executable instructions, such as program modules, being executed by a computer system. Generally, program modules may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system 12 in computing infrastructure 10 is shown in the form of a general-purpose computing device. The components of computer system 12 may include, but are not limited to, one or more processors or processing units (e.g., CPU) 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc.

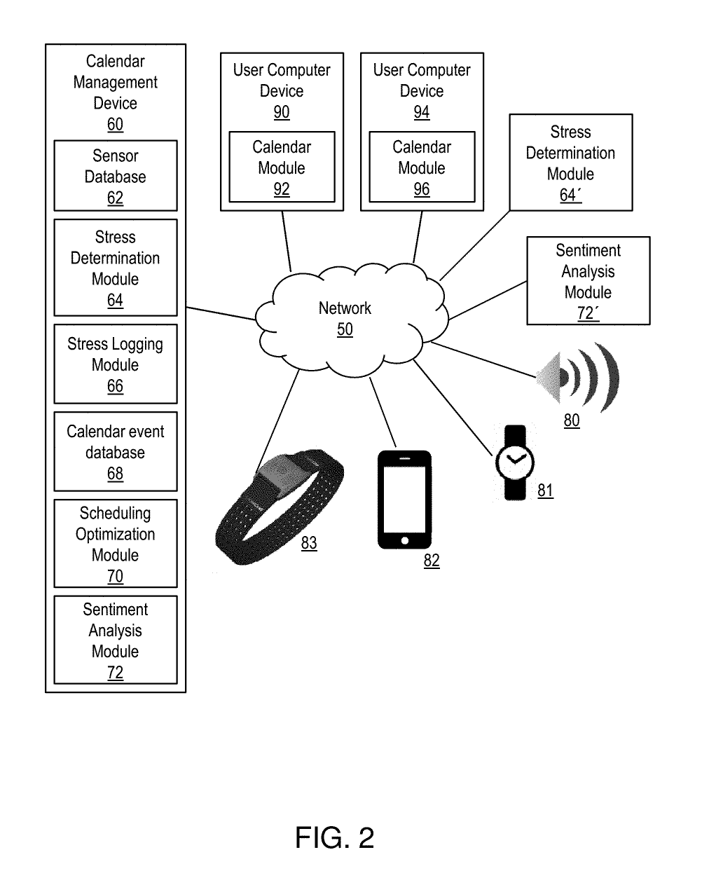

FIG. 2 shows an exemplary environment in accordance with aspects of the invention. The environment includes a calendar management device 60 connected to a network 50. The calendar management device 60 may comprise a computer system 12 of FIG. 1, and may be connected to the network 50 via the network adapter 20 of FIG. 1. The calendar management device 60 may be configured as a special purpose computing device that is in communication with one or more user computer devices 90, 94. In embodiments, the calendar management device 60 may be incorporated into a user's computer device, such as a laptop computer, smartphone, tablet, or desktop computer.

The network 50 may be any suitable communication network or combination of networks, such as a local area network (LAN), a general wide area network (WAN), and/or a public network (e.g., the Internet). The user computer devices 90, 94 may each be a general purpose computing device, such as a desktop computer, laptop computer, tablet computer, smartphone, etc. In embodiments, the user computer devices 90, 94 include respective calendar modules 92, 96, which may run a calendar application program that provides an interface between the user computer devices 90, 94 and the calendar management device 60. The calendar management device 60 may be configured to communicate with plural different user computer devices 90, 94 simultaneously, and perform search functions separately for each user computer device 90, 94 independent of the others.

Still referring to FIG. 2, in embodiments, the calendar management device 60 includes a sensor database 62 for recording stress-related data, a stress logging module 66 for logging stress elevating factors, and a calendar event database 68 for recording calendar event data. In aspects, the calendar management device 60 also includes a stress determination module 64 for analyzing the stress-related data in the sensor database 62. In aspects, a remote stress determination module 64′ may be in communication with the calendar management device 60 through the network 50. Stress determination modules 64, 64′ are configured to perform one or more of the functions described herein. The stress determination module 64 may include one or more program modules (e.g., program module 42 of FIG. 1) executed by the calendar management device 60. Likewise, the stress determination module 64′ may include components of the computer system 12. In embodiments, the stress determination modules 64, 64′ are configured to process stress-related data of a user to determine the user's stress level.

FIG. 2 depicts a variety of trackers or sensors 80-83 which may provide stress-related data for use by the stress determination modules 64, 64′. By way of example, the stress determination modules 64, 64′ may be configured to determine a user's stress level over time based on heart rate data from a biosensor 83 using conventional correlations between heart rate and stress levels. Other potential trackers for use with the present invention include wearable devices 81 such as smart watches, sound recording devices 80, and smartphones 82.

Still referring to FIG. 2, a scheduling optimization module 70 of the calendar management device 60 is configured to perform one or more of the functions described herein. The scheduling optimization module 70 may include one or more program modules (e.g., program module 42 of FIG. 1) executed by the calendar management device 60. In embodiments, the scheduling optimization module 70 is configured to determine whether a calendar event is associated with a potential undesirable elevation in a user's stress level. In aspects, the scheduling optimization module 70 is configured to provide alternative scheduling options or other remedial actions to address a potential undesirable elevation in the user's stress level. In aspects, the scheduling optimization module 70 automatically blocks off time in a user's calendar to provide blocks of recovery or de-stressing time. In aspects, the scheduling optimization module 70 presents stress level indicators for one or more calendar events or alternative scheduling options to a user to give the user a better understanding of potential stress elevating events.

An additional tracker that may be utilized is a sentiment analysis module 72, which may be configured to analyze documents or other text-based data associated with a calendaring event to determine a tone or sentiment of the user. The sentiment analysis module 72 may include one or more program modules (e.g., program module 42 of FIG. 1) executed by the calendar management device 60. In embodiments, the sentiment analysis module 72 is configured to provide sentiment or tone data related to calendar events to the stress determination module 64. For example, the sentiment analysis module 72 may determine that an email related to an upcoming meeting includes negative sentiment values. The stress determination module 64 may determine that the negative sentiment values from the email indicate that the topic of the upcoming meeting is a stress elevating factor. Alternatively, a remote sentiment analysis module 72′ may be utilized to collect sentiment data to provide to the calendar management device 60. Conventional sentiment analysis tools may be utilized to provide sentiment information to the calendar management device 60 in accordance with aspects of the invention.

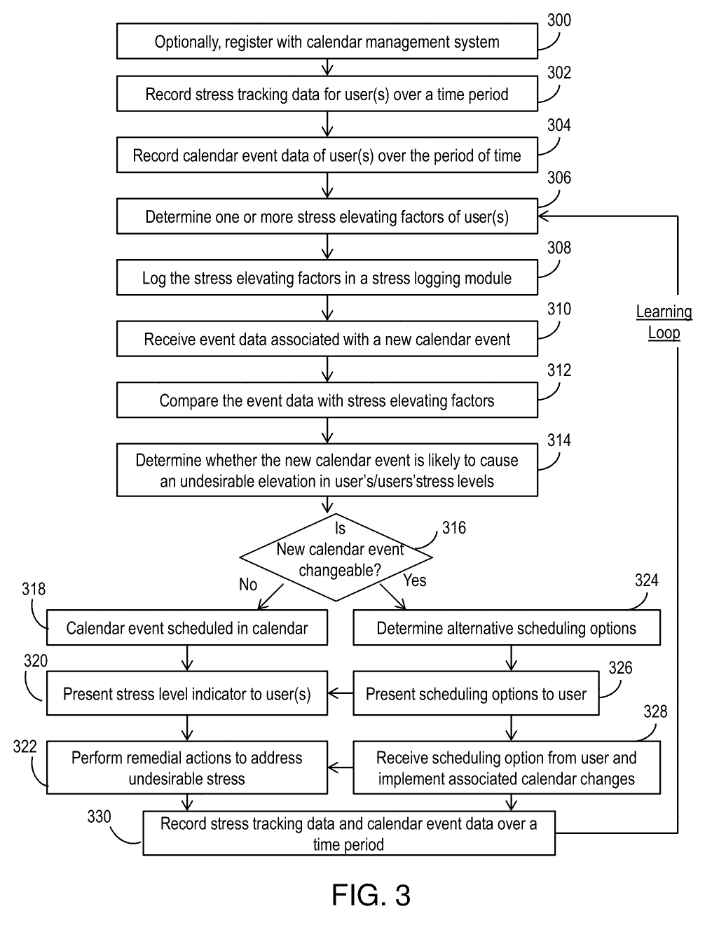

FIG. 3 shows a flowchart of a method in accordance with aspects of the invention. Steps of the method of FIG. 3 may be performed in the environment illustrated in FIG. 2, and are described with reference to elements shown in FIG. 2.

At step 300, one or more users may optionally register with the calendar management device 60. By way of example, the calendar management device 60 may provide cloud-based calendar management services to a plurality of remote user devices 90, 94. In another example, the calendar management device 60 may provide a corporation with in-house calendar management to reduce the stress of its employees. Registration information may be stored in the calendar management device 60 and used to associate users with their stress-related data and calendar data.

At step 302, stress tracking data is recorded over a period of time for one or more users. For example, an initial period of time may be from the time a user awakes to the time they retire for the day. This provides the calendar management device 60 with enough data to distinguish “everyday stress” from elevated stress. Stress tracking data may include any data from one or more trackers or sensors 80-83. By way of non-limiting example, the calendar management device 60 may record heart rate data from the biosensor (e.g., heart rate monitor) 83 in the sensor database 62. Other examples of data that can be recorded include, data regarding a user's level of participation in a meeting or a user's speaking volume (e.g., a high volume may be an indication of elevated stress) collected from a sound recording device (e.g., 80) or a smartphone (e.g., 82), heart rate and movement data from a smartwatch (e.g., 81), and sentiment data collected from a sentiment analysis tool (e.g., 72, 72′). These examples are not intended to be limiting, and it should be understood that any conventional stress-measurement data can be recorded in accordance with step 302 of the present invention.

At step 304, calendar event data is recorded over the same time period as step 302 for one or more users. In aspects the calendar management device 60 obtains calendar information from one or more user computer devices 90, 94 (e.g., from calendar modules 92, 96), and separately records the calendar event data in the calendar event database 68 for each user computer device 90, 94. Calendar event data may include any data related to one or more calendar events, including, for example, emails associated with the calendar event, topics associated with the calendar event, invitations to the calendar event, the scheduled length of the calendar event, the actual length of the calendar event, invitees to the calendar event, and participants in the calendar event.

At step 306, the calendar management device 60 determines one or more stress elevating factors for each user associated with the one or more user computer devices 90, 94. In embodiments, the calendar management device 60 first processes raw stress tracking data in sensor database 62 utilizing the stress determination module 64 in order obtain stress measurements over time. Next, the calendar management device 60 determines baseline stress levels for each user over the time period of recording the stress tracking data. The calendar management device 60 further determines a threshold stress level above which each user is determined to have an elevated stress level. This threshold stress level can be based on standard threshold stress levels taken from a look-up table, and/or may be customized based on user characteristics. In aspects, for each user, the calendar management device 60 compares the stress tracking data with the threshold stress level of the user to determine instances of elevated stress levels over the period of time. The calendar management device 60 may then correlate the instances of elevated stress levels with calendar event data to determine which calendar event data represents a stress elevating factor for a user. By way of example, User A may experience elevated stress levels during all meetings pertaining to “Matter A”. In this example, the calendar management device 60 would detect a relationship between elevated stress levels of User A and the meeting topic “Matter A”, and would determine that the topic “Matter A” is a stress elevating factor for User A.

At step 308, the calendar management device 60 logs the stress elevating factors determined at step 306 in the stress logging module 66 to generate stress profiles for each user.

At step 310, the calendar management device 60 receives calendar event data associated with a new calendar event. In embodiments, the calendar management device 60 obtains the event data from a user computer device's calendar module (e.g., 92) through the network 50. As with step 304, the calendar event data may include any data related to one or more calendar events, including, for example, emails associated with the calendar event, topics associated with the calendar event, invitations to the calendar event, the scheduled length of the calendar event, the actual length of the calendar event, invitees to the calendar event, and participants in the calendar event.

At step 312, the calendar management device 60 compares the event data from the new calendar event of step 310 with the stress elevating factors stored in the stress logging module 66 to determine if one or more stress elevating factors are associated with the new calendar event of any of the intended participants.

At step 314, the calendar management device 60 determines whether the new calendar event is likely to result in an undesirable elevation in any of the intended participant's stress levels. For example, the calendar management device 60 may detect certain undesirable stress-elevating patterns based on a user's stress profile in the stress logging module 66, and may determine that the new calendar event is likely to result in an undesirable elevation in the user's stress levels. By way of example, if a user's profile indicates that 30 minute meetings usually create low stress for the user, 60 minute meetings create medium stress for the user, and meetings with the topic “Matter A” usually create medium stress for the user, then the calendar management device 60 may decide that a 30 minute meeting on the topic of “Matter A” is acceptable, but a 60 minute meeting on the same topic would likely result in an undesirable elevation in the user's stress levels. It should be understood that threshold probability levels can be adjusted based on the users of a particular system and the scheduling and stress reducing outcomes desired. For example, the calendar management device 60 may determine that a 50% probability of increased stress over a particular threshold value is acceptable, while anything more than that is considered an undesirable probability of increased stress. By way of another example, the system may rate stress levels for events (e.g., low stress, medium stress, high stress) and may attempt to avoid certain combinations of events which lead to elevated stress ratings (e.g., adding two medium stress level events is undesirable, while adding a low stress event and a medium stress event is acceptable).

The present invention may manage both changeable and unchangeable calendar events. By way of example, a new calendar event schedule for a group of invitees may not be changeable by one or more of the invitees. Accordingly, at step 316, the calendar management device 60 may recognize or determine the type of new calendar event at issue (i.e., changeable or unchangeable) and act accordingly.

At step 318, if a new calendar event is unchangeable (e.g., the calendar event has been scheduled by an administrator), the calendar management device 60 enables the scheduling of the new calendar event on one or more users' calendars with no changes.

Optionally, at step 320, one or more users may be presented with one or more stress level indicators associated with the new calendar event, to provide respective users with information regarding potential stress-inducing circumstances related to the new calendar event. By way of example, a red exclamation point may be inserted into a user's calendar with the entry of the new calendar event to indicate to the user that the new calendar event is more likely than not to elevate the user's stress levels.

At step 322, the calendar management device 60 may take remedial actions to address an anticipated elevation in one or more users' stress levels. By way of example, the calendar management device 60 may automatically block off a period of time on a user's calendar after the new calendar event in order to introduce a period of stress relief or rest into the user's schedule. By way of another example, the calendar management device 60 may present the user with scheduling options for a later calendar event that follows the new calendar event. In this way, the calendar management device 60 can facilitate rescheduling of changeable calendar events in light of any unchangeable calendar events to optimize the user's schedule while reducing unnecessary stress.

If it is determined at step 316 that the new calendar event is changeable, then the calendar management device 60 may determine one or more alternative scheduling options at step 324. By way of example, the calendar management device 60 may determine that a 60 minute meeting on the topic of “Matter A” would be undesirable, but a 30 minute meeting on the same topic would be acceptable.

At step 326, scheduling options determined at step 324 are presented to the user (e.g., initiator of meeting). For example, in keeping with the example of step 324, the calendar management device 60 may present the option of a 30 minute meeting to a user via the user's calendar interface (e.g., a pop up screen recommending a rescheduling of the meeting).

Optionally, the calendar management device 60 may also present the user with a stress level indicator in accordance with step 320 to assist the user in making scheduling decisions.

At step 328, the calendar management device 60 receives a scheduling option from the user (e.g., meeting initiator). The scheduling option may be a rejection of all options presented to the user, or may be a selection of one of the options presented in step 326. Upon receiving an option by a user, the calendar management device 60 implements appropriate changes to one or more user calendars. For example, the calendar management device 60 may cause a 30 minute meeting to be scheduled in multiple users' calendars rather than a 60 minute meeting. Alternatively, the calendar management device 60 may present the user (e.g. meeting initiator) with additional options, if the scheduling option received by the user was a rejection of all proposed calendaring options.

Optionally, the calendar management device 60 may perform remedial actions to address undesirable stress in accordance with step 322. By way of example, the calendar management device 60 may automatically block off a period of time on one or more user calendars after the new calendar event in order to introduce a period of stress relief or rest into users' schedules.

At step 330, stress tracking data and calendar event data (including event data related to the new calendar event) are recorded over time in the same manner as in steps 302 and 304, and the steps 306-322 or 306-330 are repeated. In this way, the present invention provides a “learning loop” wherein stress tracking data related to new calendar events can be added to the system to enable the calendar management device 60 to continuously improve the accuracy of user stress profiles.

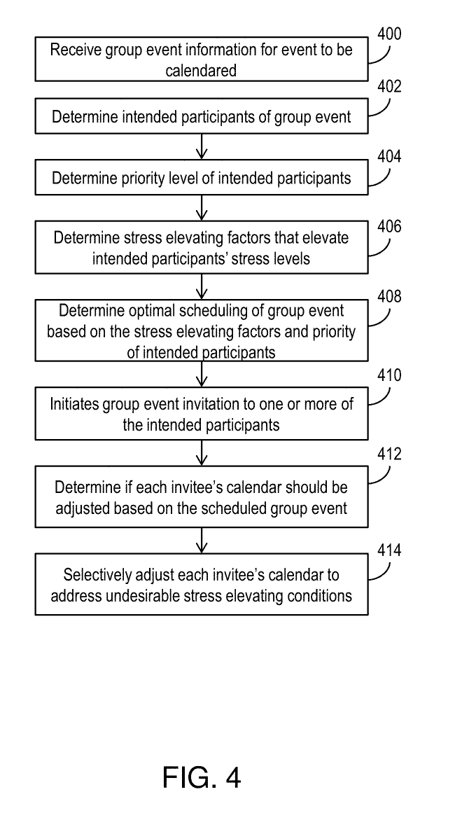

FIG. 4 shows a flowchart of a method in accordance with aspects of the invention. Steps of the method of FIG. 4 may be performed in the environment illustrated in FIG. 2, and are described with reference to elements shown in FIG. 2.

At step 400, the calendar management device 60 receives group event information for a group event (i.e., one or more intended participants) to be calendared. In embodiments, the calendar management device 60 receives the information from a calendar module (e.g., 92, 96) of a user computer device, such as the user computer device of a group administrator. The group event information may include any data related to one or more calendar events, including, for example, emails associated with the calendar event, topics associated with the calendar event, invitations to the calendar event, the scheduled length of the calendar event, the actual length of the calendar event, invitees to the calendar event, and participants in the calendar event.

At step 402, the calendar management device 60 determines the intended participants of the group event (e.g., user's associated with emails in an “Invite Attendees” row).

At step 404, the calendar management device 60 determines the priority level of the intended participants. The priority of the intended participants can be determined in a number of ways, including by determining predetermined priority levels of the intended participants recorded in look-up tables, or by receiving an indication of the priority level of each of the intended participants with the group event information at step 400. By way of example, a group administrator may designate each intended participant with a priority level (e.g., essential participant, contributory participant, or general participant) at the time of creating the group event.

At step 406, the calendar management device 60 reviews stress profiles of the intended participates to determine if any stress elevating factors of the intended participants relate to the group event. By way of example, the group event may be scheduled for 60 minutes, and the calendar management device 60 may determine that certain intended participants have elevated stress levels in meetings that last over 30 minutes.

At step 408, the calendar management device 60 determines an optimal scheduling of the group event based on each intended participant's stress elevating factors (stress profiles) and the priority level of the intended participants. The calendar management device 60 may also take into account the intended participant's current calendar schedule (i.e., events already calendared or openings in respective calendars). In embodiments, the scheduling optimization module 70 is utilized to perform step 408. By way of example, if a first intended participant is designated as a general participant in the group event, and the stress profile of the first intended participant indicates elevated stress levels in meetings that last over 30 minutes, the scheduling optimization module 70 may determine that an optimal scheduling of the group meeting is one in which the first intended participant does not participate in the meeting.

Optionally, the calendar management device 60 can present one or more scheduling options to a user or administrator for approval. For example, the calendar management device 60 may suggest an optimal time of the group meeting on “Matter A” for all mandatory attendees (e.g., essential participants) that is deemed too far away (e.g., 20 days). In this scenario, if the user/administrator rejects the suggestion, the calendar management device 60 may generate a second option, such as an option wherein less than the total number of intended participant's is invited. This process may continue until an a user/administrator approves a scheduling option presented by the calendar management device 60.

At step 410, the calendar management device 60 initiates a group event invitation to one or more of the intended participants (invitees) based on the determining step 408. By way of example, in the scenario of step 408, the first intended participant would be excluded from the group event invitation. In this way, the first intended participant will avoid experiencing elevated stress that would result from their unnecessary participation in a meeting for “Matter A”.

At step 412, the calendar management device 60 determines if each invitee's calendar should be adjusted based on the scheduled group event. By way of example, the calendar management device 60 may determine that remedial actions would be desirable for certain invitees to reduce their stress in accordance with step 322 discussed above.

At step 414, the calendar management device 60 selectively adjusts each invitee's calendar to address any undesirable elevated stress conditions introduced with the scheduling of the group event.

It should be understood that the calendar management device 60 may gather additional stress tracking data of the invitees of the group event and update each invitees respective stress profile in accordance with the steps 330, 306 and 308 of FIG. 3. More specifically, the calendar management device 60 may receive additional stress tracking data for each of the invitees from one or more tracking devices; record additional stress tracking data over a second time period to obtain recorded stress tracking data for each of the invitees; record calendar event data of the scheduled group event for each of the invitees; determine one or more additional stress elevating factors by comparing the additional stress tracking data of the invitees to the calendar event data of the scheduled group event for each of the invitees; and log the one or more additional stress elevating factors of each of the invitees in the stress logging module to update the stress profiles for each of the invitees.

Based on the steps set forth in FIGS. 3 and 4 and discussed above, it should be understood that the present invention allows individuals to attempt to control known stressors in meeting situations by limiting either by topic or attendees, the number of meetings that can happen sequentially or within a given time period based on an individual's tolerance. Advantageously, the current invention provides a method to measure current and cumulative stress levels of a user and associate the effect meeting subject matter and attendees have on those levels; to measure stress levels based on a user's level of participation in a meeting and a cognitive sentiment analysis of the user's words (e.g., emails or documents associated with the meeting); and to reschedule meetings in order to minimize stress on a user.

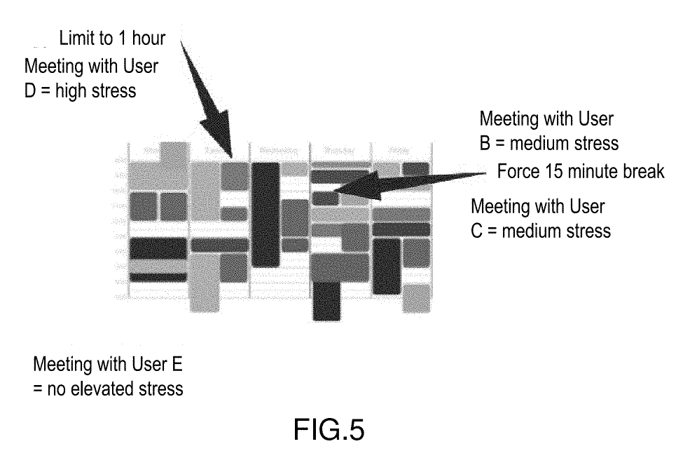

FIG. 5 depicts a user's electronic calendar in accordance with exemplary scenarios of the present invention. In a first exemplary scenario, the calendar management device 60 of the present invention has learned by using IoT sensors that a User A experiences a medium stress level when meeting with a User B. In addition, the calendar management device 60 has learned that when User A presents to a group, User A experiences a medium level of stress. A User C has scheduled a group meeting for 10:00 AM in which User A will present to the group. User B has requested a 9:00 AM to 10:00 AM meeting, in which User A will be present. The calendar management device 60 has learned that back to back medium level stress meetings usually result in User A experiences a high level of stress by the end of the second meeting, and that User A should have a 15 minute break between such meetings to reduce User A's stress. When User B's meeting request comes through to the calendar management device 60 (e.g., from user B's calendar module 92), the scheduling optimization module 70 will automatically recommend an alternative scheduling option to User B, so that User A can have a break between meetings.

Still referencing FIG. 5, in a second exemplary scenario, User D sends a 90 minute meeting request to the calendar management device 60, including User A as a intended participant. The calendar management device 60 has learned that User A experiences elevated stress during any meetings that are over 60 minutes with User D as the chair (i.e., leader). The calendar management device 60 presents an alternative scheduling option to User D that would result in a meeting of only 60 minutes.

In another exemplary scenario depicted in FIG. 5, User E requests a 2 hour meeting including User A as an intended participant. Historic data from the stress logging module 66 indicates that neither the topic of the meeting, nor the attendees, cause User A to experience any elevated stress levels. Accordingly, the calendar management device 60 makes no recommendations to alter the calendaring of User E's meeting.

In embodiments, a service provider, such as a Solution Integrator, could offer to perform the processes described herein. In this case, the service provider can create, maintain, deploy, support, etc., the computer infrastructure that performs the process steps of the invention for one or more customers. These customers may be, for example, any business that uses electronic calendaring technology for scheduling purposes. In return, the service provider can receive payment from the customer(s) under a subscription and/or fee agreement and/or the service provider can receive payment from the sale of advertising content to one or more third parties.

In still another embodiment, the invention provides a computer-implemented method for managing calendars to reduce user stress. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for managing electronic calendars to reduce user stress, comprising:
receiving, by a computing device, electronic calendar event data associated with electronic calendar events of a user's electronic calendar over a time period, including text-based data;
determining, by a sentiment analysis module of the computing device, sentiment data from the text-based data;
determining, by the computing device, one or more instances of elevated stress levels of the user over the time period based on the sentiment data;
determining, by the computing device, one or more stress elevating factors of the user by comparing the electronic calendar event data with the one or more instances of elevated stress levels;
receiving, by the computing device, new electronic calendar event data associated with a new electronic calendar event of the user's electronic calendar;
determining, by the computing device, that the new calendar event is associated with a potential undesirable elevation in the user's stress level based on the comparing the new electronic calendar event data with the one or more stress elevating factors; and
providing, by the computing device, the user's electronic calendar with one or more stress level indicators associated with the new electronic calendar event based on the determining that the new calendar event is associated with a potential undesirable elevation in the user's stress level.

2. The computer-implemented method of claim 1, further comprising:
receiving, by the computing device, stress tracking data of the user from one or more tracking devices over the time period;
recording, by the computing device, the stress tracking data over the time period to obtain recorded stress tracking data;
recording, by the computing device, the calendar event data of the user over the time period; and
logging, by the computing device, the one or more stress elevating factors of the user in a stress logging module to create a stress profile of the user.

3. The computer-implemented method of claim 1, further comprising presenting, by the computing device, at least one alternative calendar scheduling option to the user regarding the new calendar event for rescheduling the new calendar event; wherein the at least one alternative calendar scheduling option is configure to remediate the potential undesirable elevation in the user's stress level.

4. The computer-implemented method of claim 3, further comprising:
receiving, by the computing device, a selection of the at least one calendar scheduling option from the user; and
implementing, by the computing device, changes to the user's electronic calendar based on the selection.

5. The computer-implemented method of claim 2, further comprising:
determining, by the computing device, baseline stress levels of the user based on the recorded stress tracking data; and
determine, by the computing device, a threshold stress level above which the user is determined to have an elevated stress level;
wherein the determining the stress elevating factors comprises comparing the stress tracking data with the threshold stress level of the user to determine instances of elevated stress levels over the time period and correlating the calendar event data over the time period to the instances of elevated stress levels, wherein calendar event data correlated with the instances of elevated stress levels are determined to be the stress elevating factors.

6. The computer-implemented method of claim 1, wherein the event data associated with the new calendar event includes at least one selected from the group consisting: of a date of the new calendar event; a time of the new calendar event; a topic of the new calendar event; invitees of the new calendar event; and participants of the new calendar event.

7. The computer-implemented method of claim 1, wherein the tracking device is a biosensor.

8. The computer-implemented method of claim 1, further comprising automatically blocking out, by the computing device, a period of time after the new calendar event on the user's electronic calendar.

9. The computer-implemented method of claim 1, wherein the new calendar event is a group event, and the determining whether the new calendar event is associated with a potential undesirable elevation in the user's stress level includes determining whether the group event is associated with a potential undesirable elevation in the stress levels of intended participants in the group event, including the user, the method further comprising:
determining, by the computing device, the intended participants in the group event;
determining, by the computing device, the priority level of the intended participants, wherein the priority levels include the priority levels of essential participant, contributory participant and general participant; and
determining, by the computing device, an optimal scheduling of the group event based on the one or more stress elevating factors of each of the intended participants and the priority level of each of the intended participants; and
initiating, by the computing device, a group event invitation to respective electronic calendars of one or more of the respective intended participants.

10. The computer-implemented method of claim 9, wherein the initiating the group event invitation comprises initiating the group event invitation to less than a total number of the intended participants based on the optimal scheduling of the group event.

11-20. (canceled)

21. A computer-implemented method for managing electronic calendars to reduce user stress, comprising:
receiving, by a computing device, electronic calendar event data including text-based data associated with electronic calendar events of a user's electronic calendar;
receiving, by the computing device, stress tracking data of the user over a period of time from one or more sensors;
determining, by the computing device, one or more instances of elevated stress levels of the user over the period of time based on the stress tracking data;
determining, by a sentiment analysis module of the computing device, sentiment data from the text-based data;
determining, by the computing device, one or more stress elevating factors of the user by comparing the electronic calendar event data with the one or more instances of elevated stress levels and the sentiment data, wherein the one or more stress elevating factors comprise at least two of the calendar event data selected from the group consisting of: one or more invitees to an electronic calendar event, one or more participants of an electronic calendar event, and a topic of an electronic calendar event;
receiving, by the computing device, new electronic calendar event data associated with a new electronic calendar event of the user's electronic calendar;
determining, by the computing device, that the new calendar event is associated with a potential undesirable elevation in the user's stress level based on the comparing the new electronic calendar event data with the one or more stress elevating factors; and
implementing changes, by the computing device, to the user's electronic calendar based on the determining that the new calendar event is associated with a potential undesirable elevation in the user's stress level.

22. The computer-implemented method of claim 21, wherein the at least two of the calendar event data comprises the one or more invitees to an electronic calendar event and the topic of an electronic calendar event.

23. The computer-implemented method of claim 21, further comprising presenting, by the computing device, at least one alternative calendar scheduling option to the user regarding the new calendar event for rescheduling the new calendar event; wherein the at least one alternative calendar scheduling option is configure to remediate the potential undesirable elevation in the user's stress level.

24. A computer-implemented method for managing electronic calendars to reduce user stress, comprising:
receiving, by a computing device, electronic calendar event data associated with electronic calendar events of a user's electronic calendar, the calendar event data including text-based data including: email related to one or more calendar events, one or more invitees to the electronic calendar events, one or more participants of the electronic calendar events, and one or more topics of the electronic calendar events;
receiving, by the computing device, stress tracking data of the user over a period of time from one or more sensors;
determining, by a sentiment analysis module of the computing device, sentiment data from the calendar event data;
determining, by the computing device, one or more instances of elevated stress levels of the user over the period of time based on the stress tracking data and the sentiment data;
determining, by the computing device, one or more stress elevating factors of the user by comparing the electronic calendar event data with the one or more instances of elevated stress levels;
receiving, by the computing device, new electronic calendar event data associated with a new electronic calendar event of the user's electronic calendar;
determining, by the computing device, that the new calendar event is associated with a potential undesirable elevation in the user's stress level based on the comparing the new electronic calendar event data with the one or more stress elevating factors; and
presenting, by the computer device, one or more alternative scheduling options for rescheduling the new electronic calendar event, wherein the one or more alternative scheduling options are configured to remediate the potential undesirable elevation in the user's stress level.

25. The computer-implemented method of claim 24, further comprising:
receiving, by the computing device, a selection of the at least one calendar scheduling option from the user; and
implementing, by the computing device, changes to the user's electronic calendar based on the selection.
